(19) United States
(12) Patent Application Publication
(10) Pub. No.: US 2015/0123015 A1
(43) Pub. Date: May 7, 2015

(54) APPARATUS AND METHODS FOR IRRADIATING SUBSTRATES WITH ULTRAVIOLET LIGHT

(71) Applicant: Nordson Corporation, Westlake, OH (US)

(72) Inventors: James V. Bachman, Lorain, OH (US); James M. Borsuk, Westlake, OH (US); Edward C. McGhee, Powell, OH (US); James C. Smith, Amherst, OH (US)

(21) Appl. No.: 14/531,378

(22) Filed: Nov. 3, 2014

Related U.S. Application Data
(60) Provisional application No. 61/899,409, filed on Nov. 4, 2013.

(51) Int. Cl. H01J 65/04

(52) U.S. Cl. CPC H01J 65/044
USPC 250/492.1; 250/493.1

(57) ABSTRACT

An apparatus for generating ultraviolet light for irradiating a substrate. The apparatus includes a housing enclosing an interior space. The housing includes an inlet for receiving a cooling air flow, and a window configured to emit ultraviolet light and discharge the cooling air flow. A lamp bulb is mounted within the interior space between the inlet and the window. First and second microwave generators are mounted between the inlet and the lamp bulb. A plate is positioned between the inlet and the first and second microwave generators, the plate at least partially defining a plenum within the housing and including first and second openings generally aligned with the respective first and second microwave generators to direct first and second portions of the cooling air flow at the first and second microwave generators.

### CROSS-REFERENCE TO RELATED APPLICATION

This application claims the benefit of Application Ser. No. 61/899,409, filed Nov. 4, 2013 (pending), the disclosure of which is hereby incorporated by reference herein.

### TECHNICAL FIELD

The present invention relates generally to microwave-excited ultraviolet lamp systems and methods.

### BACKGROUND

Ultraviolet lamp systems or lamp heads are used in many applications. For example, systems may be used for heating or curing of adhesives, sealants, inks or other coatings or for other purposes such as surface treatments. These systems typically couple microwave energy to an electrodeless lamp, such as an ultraviolet (UV) plasma lamp bulb mounted within a microwave chamber of the lamp system. In many ultraviolet lamp systems, one or more magnetrons are provided in the lamp head housing to direct microwave radiation to the plasma lamp bulb within the microwave chamber. The magnetrons are coupled to the microwave chamber through waveguides that include output ports connected to an upper end of the chamber. When the plasma lamp bulb is sufficiently excited by the microwave energy, it emits ultraviolet radiation through an open lamp face of the lamp system to irradiate a substrate which is positioned at an optimal distance from the open lamp face.

A source of forced air is fluidly connected to a housing of the lamp system which contains the magnetrons, the microwave chamber and the plasma lamp bulb. The source of forced air is operable to direct cooling air, such as 350 CFM of cooling air for example, through the housing and into the microwave chamber to cool the magnetrons and the plasma lamp bulb during irradiation of the substrate by the lamp system.

In some UV heating and curing applications, the lamp system includes a mesh screen mounted at the open lamp face. The screen is transmissive to ultraviolet radiation but is opaque to microwaves. The configuration of the mesh screen also permits the significant airflow of cooling air to pass therethrough and toward the substrate.

In other applications, the substrates irradiated by the UV lamp may be rather wide and require multiple lamp heads to be mounted adjacent one another across the width of the substrate. The substrate is then moved relative to the lamp heads in order to irradiate the entire surface of the substrate that is facing the lamp heads. For example, these substrates may comprise large, flat panels used for flat screen televisions, or films such as those used for tinting windows. In such cases, it is important to provide uniform exposure of ultraviolet radiation across the full width of the substrate. A problem that has developed involves the occurrence of “striping” in which thin bands or stripes of underexposed substrate areas occur generally between the adjacent lamp heads.

Therefore, it would be desirable to provide continued improvements in this area to provide more effective cooling within a lamp head housing, and to provide more uniform ultraviolet irradiation to wide substrates when using multiple, adjacently mounted lamp heads.

These and other features of the various embodiments of this invention will become more readily apparent to those of ordinary skill upon review of the following detailed description of the illustrated embodiments taken in conjunction with the accompanying drawings.

### SUMMARY

In an illustrative embodiment the invention provides an apparatus for generating ultraviolet light for irradiating a substrate. The apparatus includes a housing enclosing an interior space. The housing includes an inlet for receiving a cooling air flow, and a window configured to emit ultraviolet light and discharge the cooling air flow. A lamp bulb is mounted within the interior space between the inlet and the window. First and second microwave generators are respectively mounted between the inlet and the lamp bulb. A plate structure is positioned between the inlet and the first and second microwave generators. The plate structure at least partially defines a plenum within the housing and includes first and second openings generally aligned with the respective first and second microwave generators to direct first and second portions of the cooling air flow at the first and second microwave generators. The plate structure may comprise more than one plate, or may be constructed from multiple, distinct plates. The housing further comprises a top side and a rear side. The inlet is located in the top side, and the plate structure extends from the top side to the rear side. The plate structure includes a section oriented at an acute angle relative to vertical between the top side and the rear side.

The invention further provides a method of irradiating a substrate with ultraviolet light from at least first and second apparatus. Each apparatus includes a housing holding an ultraviolet lamp bulb and including a window. The method comprises mounting the first and second apparatus adjacent to one another with the ultraviolet lamp bulbs extending generally parallel to each other along their respective lengths. The substrate is positioned at an optimal distance from the windows of the first and second apparatus. The first and second apparatus and the substrate are moved relative to one another in a direction perpendicular to the respective lengths of the ultraviolet lamp bulbs. While moving the first and second apparatus and the substrate relative to one another, ultraviolet light is emitted from each apparatus through the respective windows such that adjacent patterns of ultraviolet light are directed onto the substrate. The patterns emitted from the adjacent apparatus meet on the substrate to prevent underexposed areas along the substrate at the locations generally between the adjacent first and second apparatus. Mounting the first and second apparatus further comprises mounting the first and second apparatus in abutting, contacting relationship to one another. Mounting the first and second apparatus also further comprises orienting the ultraviolet lamp bulbs to extend coaxial relative to each other along their respective lengths.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

FIG. 1 is a cross sectional view of an apparatus for irradiating substrates with ultraviolet light, constructed in accordance with the prior art.

FIG. 2 is a perspective view a portion of a housing associated with an apparatus for irradiating substrates with ultraviolet light, and constructed in accordance with an illustrative embodiment of the invention.

FIG. 3 is a perspective view of the plate structure forming the plenum of the housing shown in FIG. 2.

FIG. 4 is a cross sectional view of an apparatus for irradiating substrates with ultraviolet light, and constructed in accordance with an illustrative embodiment of the invention.

FIG. 5 is an enlarged portion of the cross sectional view shown in FIG. 4, and illustrating the lower section of the apparatus irradiating a substrate with ultraviolet light.

FIG. 6 is a cross sectional view taken along line 6-6 of FIG. 1.

FIG. 7 is a cross sectional view taken along line 7-7 of FIG. 5.

FIG. 8 is a cross sectional view showing two apparatus of the prior art placed side-by-side in abutting relation and irradiating a substrate with ultraviolet light.

FIG. 8A is a top view schematically illustrating the resulting substrate and the “striping” effect generally formed on the substrate in an area of the substrate between the two apparatus.

FIG. 9 is a cross sectional view showing two apparatus of the invention placed side-by-side in abutting relation and irradiating a substrate with ultraviolet light.

FIG. 9A is a top view schematically illustrating the resulting uniformly irradiated substrate with no “striping” effect.

### DETAILED DESCRIPTION

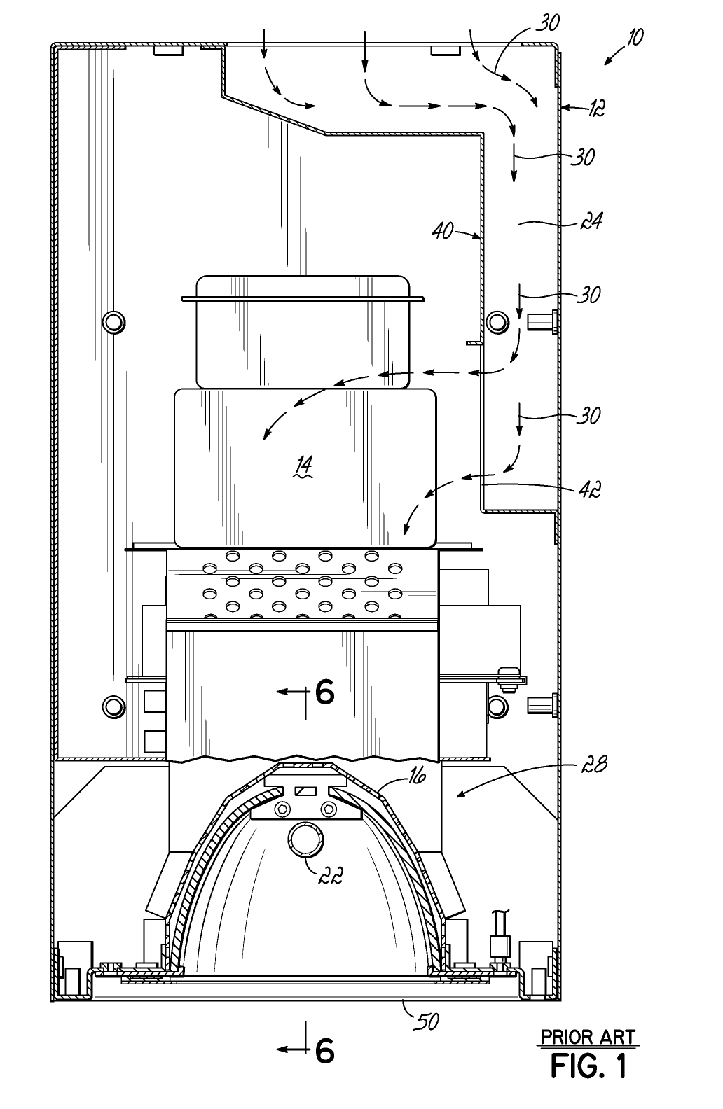

FIG. 1 illustrates a microwave excited ultraviolet lamp system or apparatus 10 constructed in accordance with the prior art. Specifically, apparatus 10 includes a housing 12 containing a pair of microwave generators, illustrated as a pair of magnetrons 14 (only one shown) that are each coupled to a longitudinally extending microwave chamber 16. An electrodeless plasma lamp 22, in the form of a sealed, longitudinally extending plasma lamp bulb, is mounted within the microwave chamber 16 and supported adjacent the upper end of the chamber 16. Housing 12 includes an inlet 12a on a top side 12b connected in fluid communication with a source of pressurized air for purposes of accepting a cooling air flow within the housing 12. A plenum 24 is located at an upper end of the housing 12, while a lower end of the housing 12 forms a lamp head 28. The source of pressurized air directs a cooling air flow, represented diagrammatically by arrows 30, through the plenum 24 and at the magnetrons 14, as well as the lamp bulb 22. The plenum 24 is formed by a plate structure 40 having a single opening 42 for directing the air at the pair of magnetrons 14. The plate structure 40 extends from the top side 12b of the housing 12 to a rear side 12c of the housing 12. Ultraviolet light from the bulb 22 is emitted through an open face or window 50.

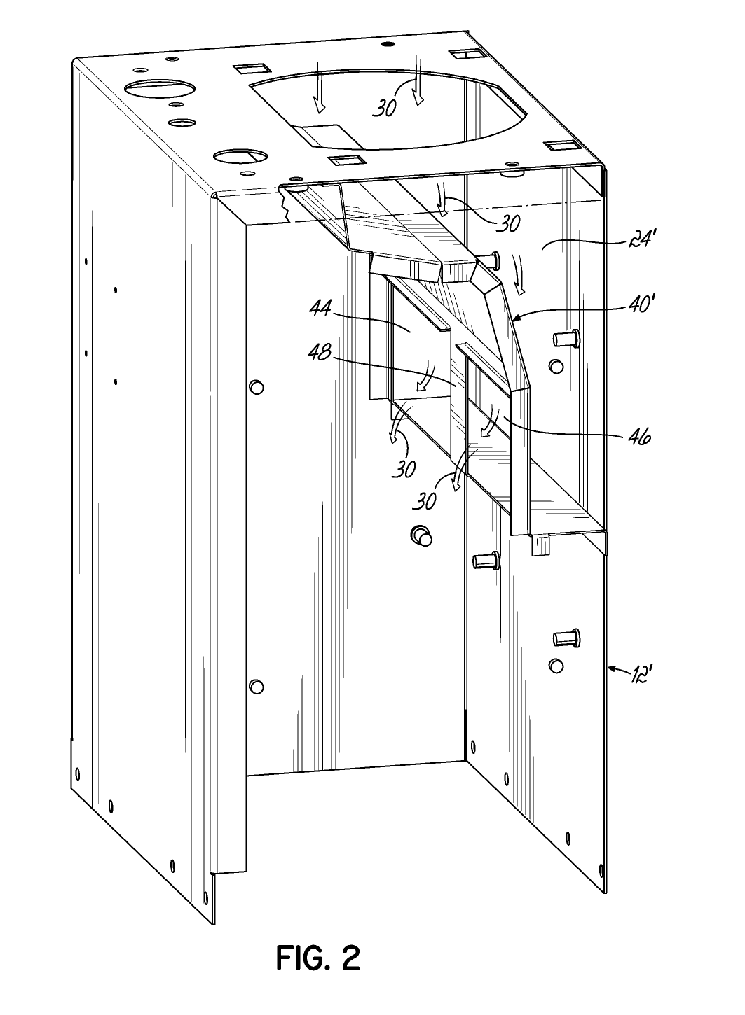

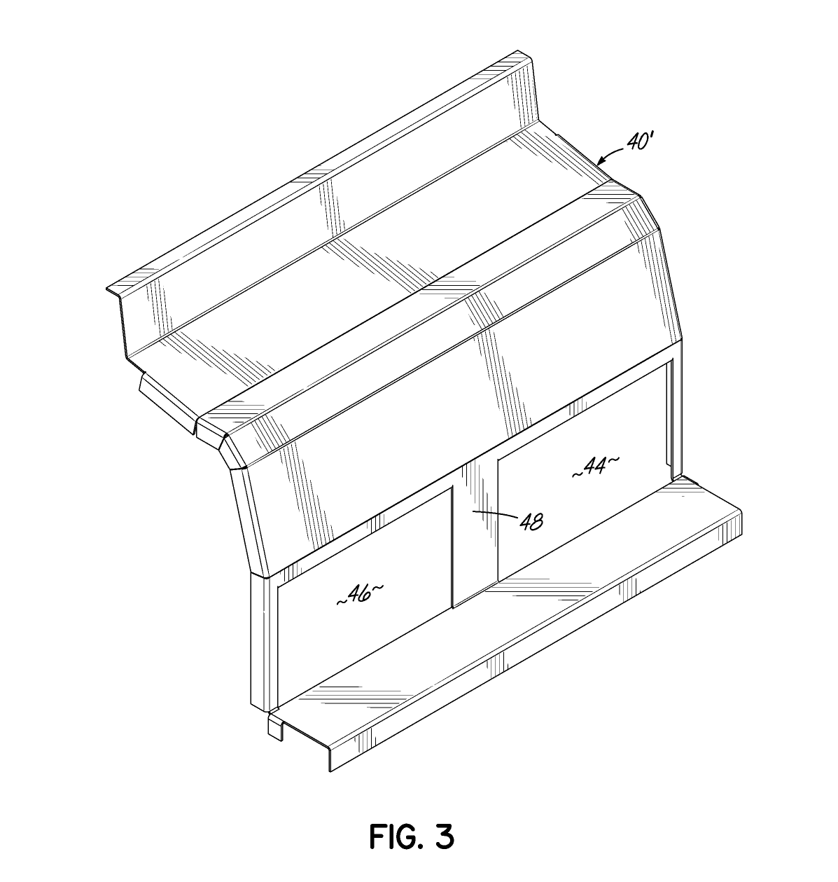

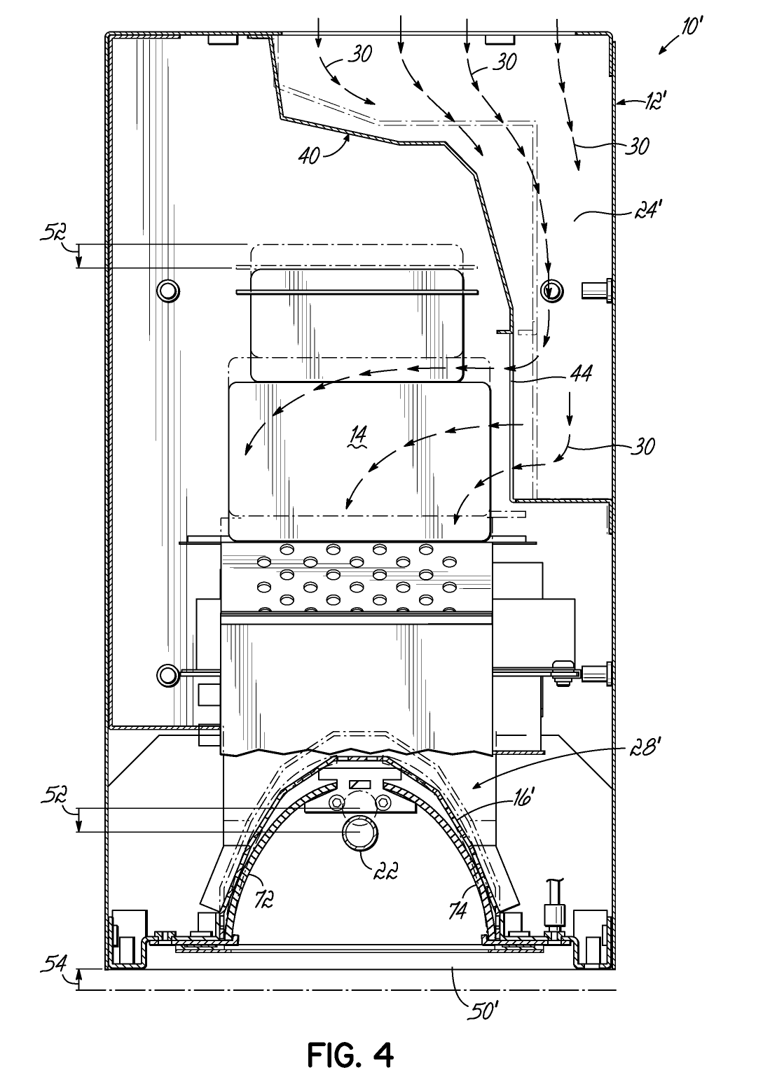

Now referring to FIGS. 2-4, an apparatus 10′ constructed in accordance with various aspects or embodiments of the present invention is shown. In these figures, like structure is indicated by like reference numerals and, therefore, additional explanation of such structure is unnecessary. Corresponding elements that have been changed in design are indicated with the same numerals as in FIG. 1, but with prime (′) marks. The differences in design are either discussed herein or apparent from a review of the drawings. As best shown in FIGS. 2 and 3, a plenum 24′ of the apparatus 10′ is constructed with an angular plate structure 40′ that provides a larger plenum 24′ than plenum 24 and also provides a pair of openings 44, 46 separated by a blocking portion 48 of the plate structure 40′. The plate structure includes sections 40a′, 40b′ oriented at acute angles, relative to vertical, for purposes of enlarging the plenum 24′ and assisting air flow. The plate structure 40′ extends from the top side 12b′ of the housing 12′ to the rear side 12c′ of the housing 12′. The separate openings 44, 46 ensure that separate flows of cooling air are directed at the respective magnetrons 14 for more efficient and effective cooling of each magnetron 14. For ease of comparison, the structure of apparatus 10′ is shown in solid lines, while the structure of the prior art apparatus 10 is shown in dash-dot lines in FIG. 4. Thus, it will also be appreciated that the assembly of the magnetrons 14 and the lamp bulb 22 also have been moved, as a unit, closer to a window or open face 50′ of the housing 12′ as indicated by arrows 52. In addition, the housing 12′ has been shortened by an amount indicated by the arrow 54 to thereby bring the window 50′ closer to the lamp bulb 22. The width of the window 50′ (parallel to the lengthwise dimension of the lamp bulb 22) is also maximized to increase the area of ultraviolet light emission as much as possible.

As will be appreciated from the discussion to follow, these features help to provide a wider pattern of ultraviolet light emission from the window 50′ and, when multiple apparatus 10′ are mounted adjacent each other, helps to eliminate the striping issue discussed above. More specifically, because the assembly of the magnetrons 14 and the lamp bulb 22 has been moved closer to the window 50′, this effectively ensures that more of the scattered ultraviolet light at the ends of the window 50′ spreads farther outwardly onto the substrate 60. The outward spreading of the light energy provides sufficient overlap between adjacent apparatus 10′ that the areas on the substrate 60 generally between the adjacent apparatus 10′ are sufficiently irradiated thereby providing uniform irradiation across the entire width of the substrate. This is accomplished while maintaining the proximity of the window 50′ at an optimal height or distance from the substrate, as opposed to moving farther from the substrate where the intensity of the ultraviolet radiation would be less.

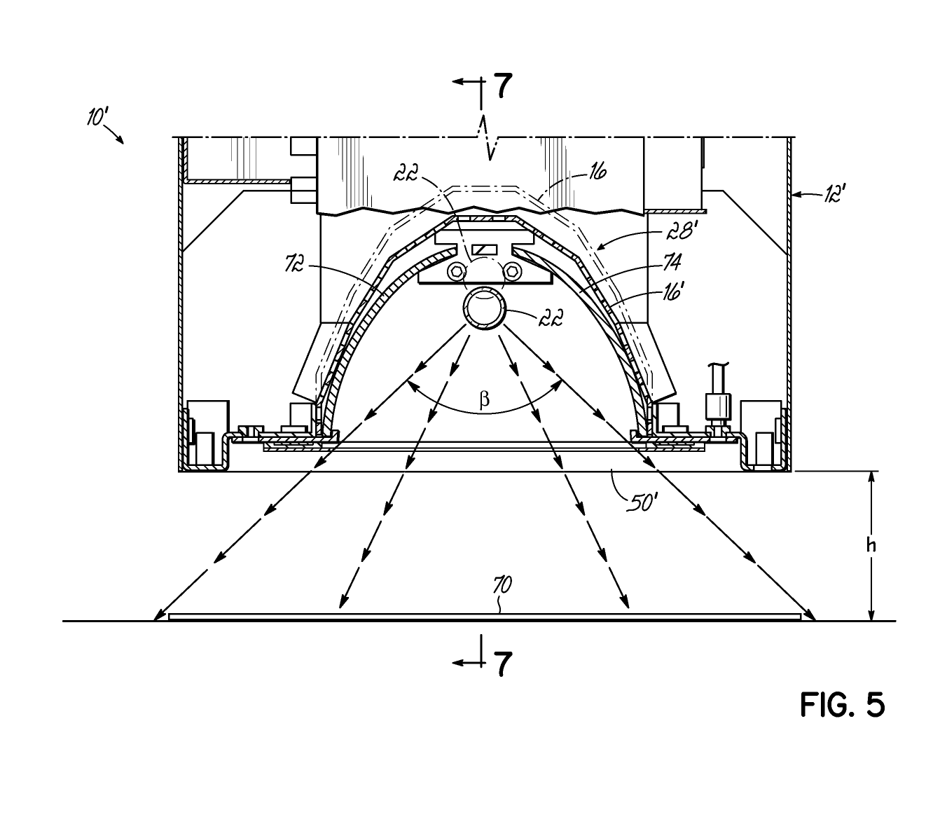

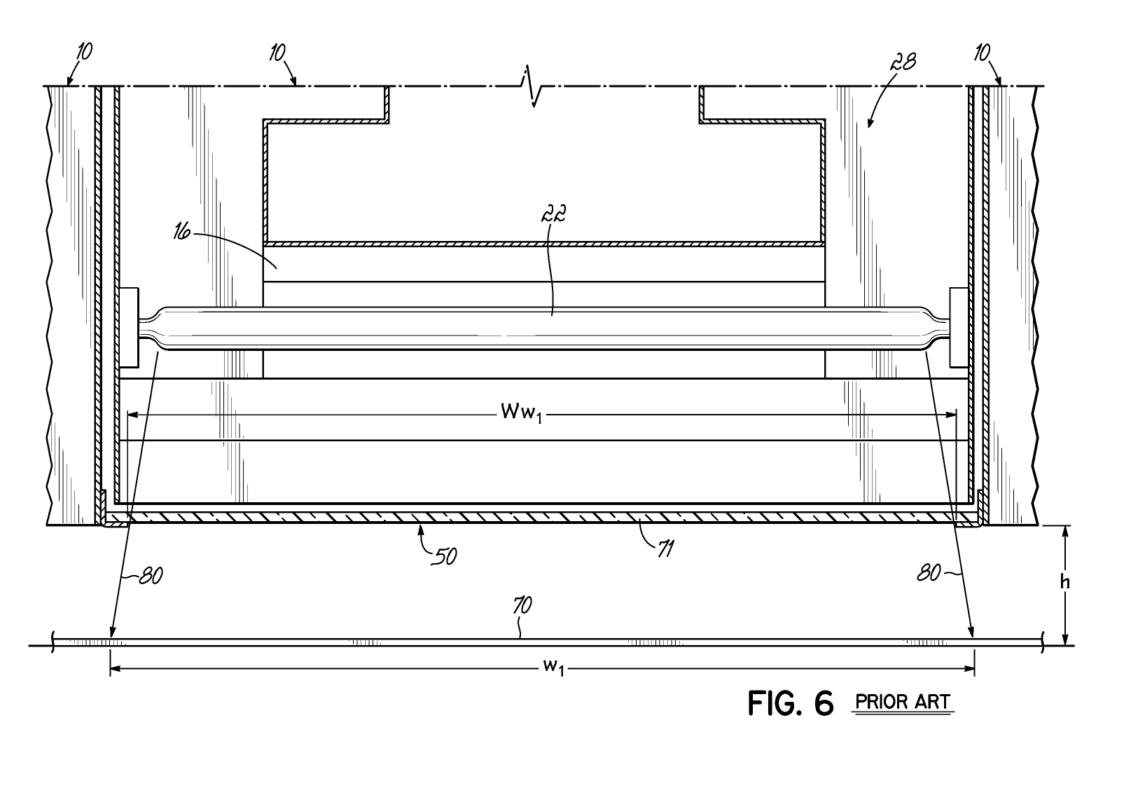

FIG. 5 illustrates an enlarged cross sectional view of the lower end of the apparatus 10′ and, specifically, the lamp head 28. This more specifically shows how the lowering of the magnetron assembly 14 (FIG. 4) and lamp head 28 relative to the window 50′ provides a wider scatter pattern of ultraviolet light through the window 50′. These figures also show a substrate 70 located at an optimal distance or height “h” from the window 50′. As is known, and illustrated in FIG. 6, a screen 71 is provided for preventing RF radiation or microwaves from passing through the window 50′, but allowing ultraviolet light to pass through. The scatter pattern of ultraviolet light is shown as occurring within angle β in FIG. 5 with the substrate 70 moving in a direction left to right or right to left as viewed in FIG. 5. The scatter pattern β is relatively wide in this direction due to use of the reflectors 72, 74, as is known in the art.

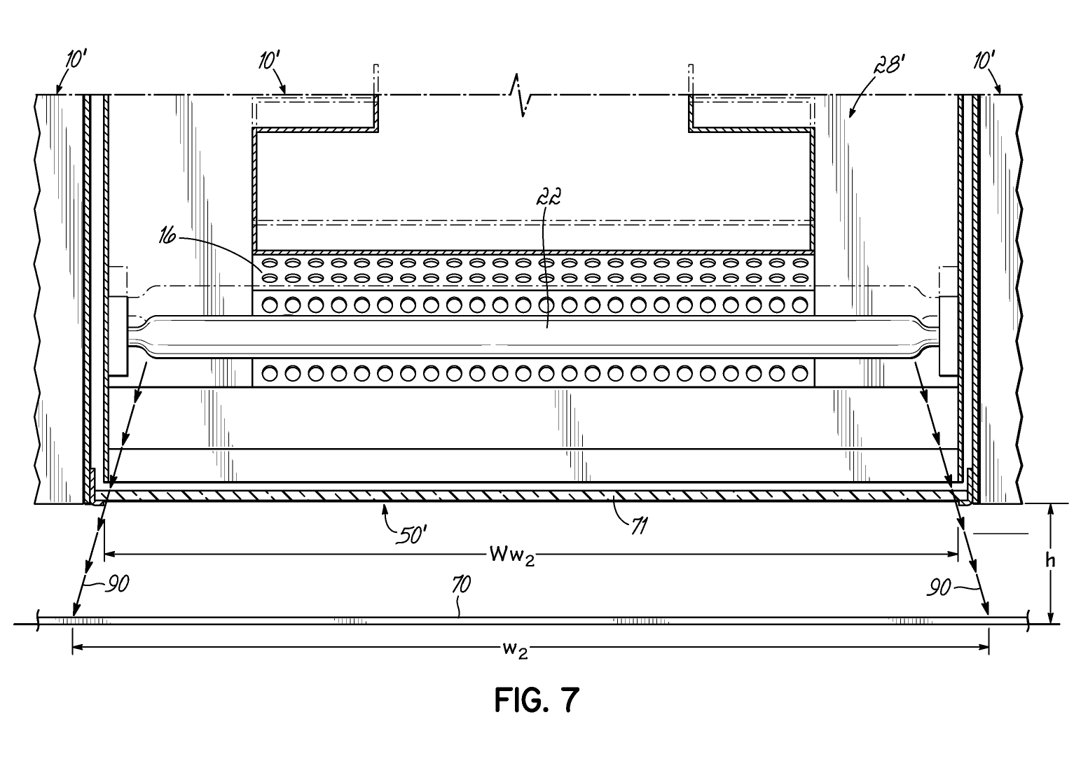

Referring to FIG. 6, in a direction perpendicular to that shown in FIG. 5, (i.e., a width direction perpendicular to the path of the substrate) the scatter pattern of ultraviolet light is shown by arrows 80 to be a much smaller angle than the angle β in FIG. 5. This is because the reflectors 72, 74 (FIG. 5) are not designed to reflect the light in these directions, but instead there is extraneously scattered light which is emitted in these directions. In this regard, FIG. 7 illustrates a view similar to FIG. 6 but showing apparatus 10′ of the invention. Apparatus 10, of the prior art, has a scatter pattern of ultraviolet light that covers a width w₁ (FIG. 6) which is less than the scatter pattern width w₂ (FIG. 7) of apparatus 10′ with the window 50′ placed at the same optimal distance or height “h” from the substrate. The wider scatter pattern width w₂ is shown by arrows 90 and occurs due to the combination of the effects of lowering the magnetrons 14 (FIG. 4) and lamp head assembly 28′ from the locations illustrated in dash-dot lines in FIG. 7, to the locations shown in solid lines in FIG. 7, in addition to slightly widening the window width from a width Ww₁ (FIG. 6) to a width Ww₂ (FIG. 7). It will also be appreciated that the dimensions of the lamp head 28′ have been changed relative to lamp head 28, including shortening the structure forming the microwave chamber 16′.

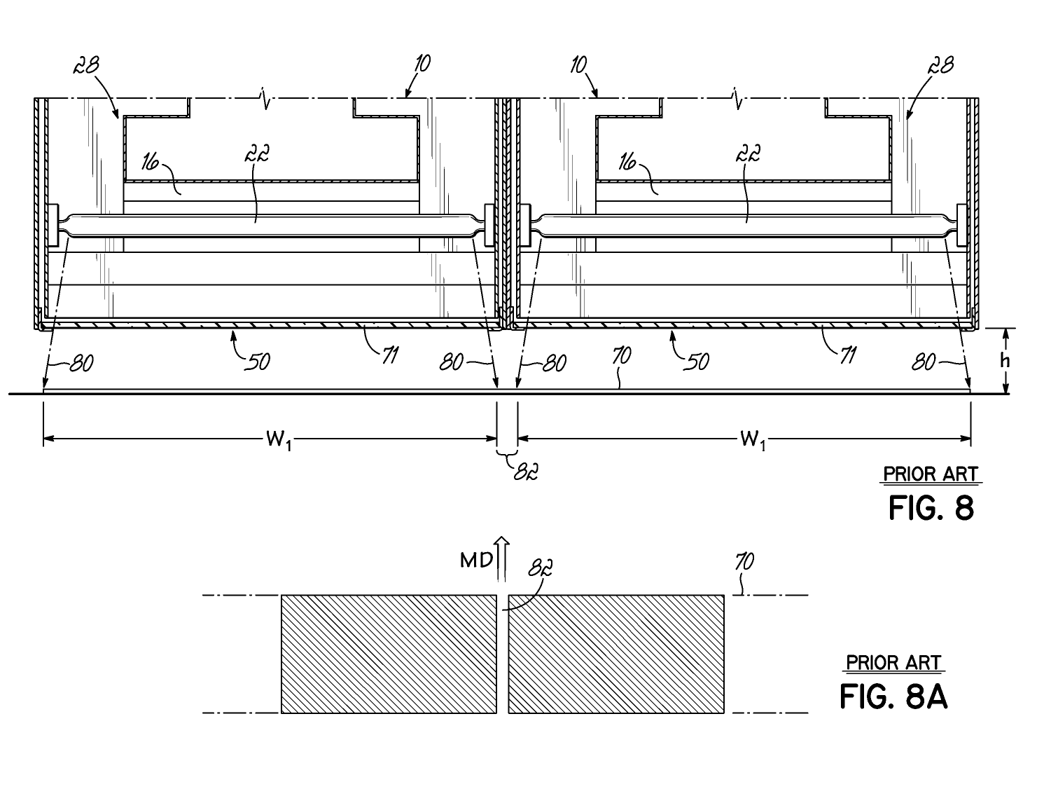

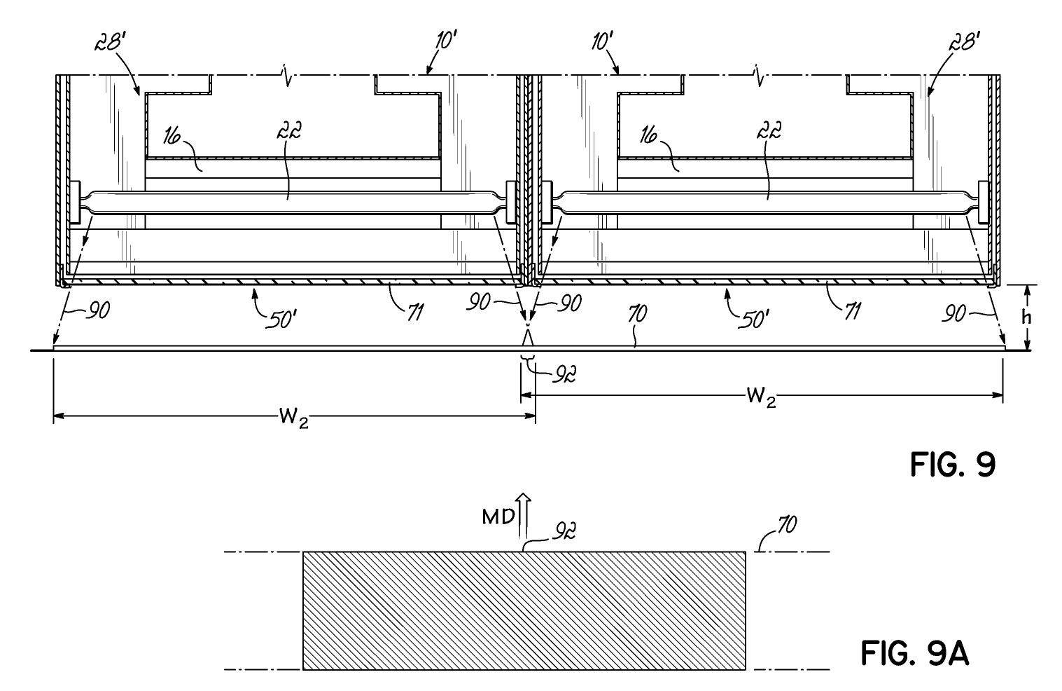

As shown in FIGS. 8, 8A, 9 and 9A, the effects of the changes discussed with regard to FIGS. 6 and 7 are schematically illustrated in a situation involving multiple apparatus 10 and 10′ respectively placed in adjacent, and more preferably abutting, contacting side-by-side relation above a wide substrate 70, and at the optimal distance or height “h” from the substrate 70. FIG. 8 illustrates the prior art apparatus 10 mounted in abutting, contacting relationship and with the lamp bulbs 22 in a colinear or coaxial relation to each other and the resulting scatter pattern of ultraviolet light indicated by the arrows 80. This results in inadequately irradiated “stripe” or lengthwise area 82 along the substrate 70 (as viewed along the machine direction MD) because the ultraviolet light emitted between the two apparatus 10 does not irradiate the stripe area with sufficient intensity. As shown, the machine direction MD is perpendicular to the lengths of the respective bulbs 22. On the other hand, with the apparatus 10′ of the invention in the same abutting, contacting side-by-side relation, the scatter pattern of ultraviolet light indicated by the arrows 90 is wider due to the effects of lowering the magnetron assemblies 14 (FIG. 4) and lamp head 28′ and slightly widening the window 50′ such that the area 92 between the apparatus 10′ is irradiated with ultraviolet light of sufficient intensity to prevent the striping effect, as schematically illustrated in FIG. 9A. This is because the scatter patterns 90 spreading outwardly toward each other and between the adjacent apparatus 10 either meet or overlap at the surface of the substrate 70, as shown in FIG. 9.

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method and illustrative examples shown and described. Accordingly, departures may be from such details without departing from the scope of the general inventive concept.

What is claimed is:

1. An apparatus for generating ultraviolet light for irradiating a substrate, the apparatus comprising:
a housing enclosing an interior space, said housing including an inlet for receiving a cooling air flow, and a window configured to emit ultraviolet light and discharge the cooling air flow;
a lamp bulb mounted within said interior space between said inlet and said window;
first and second microwave generators, each mounted between said inlet and said lamp bulb; and
a plate structure positioned between said inlet and said first and second microwave generators, said plate structure at least partially defining a plenum within said housing and including first and second openings generally aligned with the respective first and second microwave generators to direct first and second portions of the cooling air flow at the first and second microwave generators.

2. The apparatus of claim 1, wherein said housing further comprises a top side and a rear side, said inlet located in said top side, and said plate structure extends from said top side to said rear side, and includes a section oriented at an acute angle relative to vertical between said top side and said rear side.

3. A method of irradiating a substrate with ultraviolet light from at least first and second apparatus, each apparatus including a housing holding an ultraviolet lamp bulb and including a window, comprising:
mounting the first and second apparatus adjacent to one another with the ultraviolet lamp bulbs extending generally parallel to each other along their respective lengths;
positioning the substrate at an optimal distance from the windows of the first and second apparatus;
moving the first and second apparatus and the substrate relative to one another in a direction perpendicular to the respective lengths of the ultraviolet lamp bulbs; and
while moving the first and second apparatus and the substrate relative to one another, emitting the ultraviolet light from each apparatus through the respective windows such that adjacent patterns of ultraviolet light are directed onto the substrate, and the patterns emitted from the adjacent apparatus meet on the substrate to prevent underexposed areas along the substrate at the locations generally between the adjacent first and second apparatus.

4. The method of claim 3, wherein mounting the first and second apparatus further comprises:
mounting the first and second apparatus in abutting, contacting relationship to one another.

5. The method of claim 4, wherein mounting the first and second apparatus further comprises:
mounting the first and second apparatus with the ultraviolet lamp bulbs extending coaxially to each other along their respective lengths.
